(19) United States
(12) Patent Application Publication
(10) Pub. No.: US 2021/0214007 A1
(43) Pub. Date: Jul. 15, 2021

(54) METHOD FOR PROVIDING ASSISTANCE IN A PARKING MANEUVER OF A VEHICLE COMBINATION OF TOWING VEHICLE AND TRAILER, SYSTEM AND VEHICLE COMBINATION

(71) Applicant: Robert Bosch GmbH, Stuttgart (DE)

(72) Inventors: Hartmut Loos, Hildesheim (DE); Patrick Klie, Hildesheim (DE); Thomas Focke, Ahrbergen (DE)

(21) Appl. No.: 17/055,372

(22) PCT Filed: May 9, 2019
(86) PCT No.: PCT/EP2019/061949

§ 371 Date: Nov. 13, 2020

(30) Foreign Application Priority Data
Jul. 3, 2018 (DE) 10 2018 210 877.3

(51) Int. Cl. B62D 15/02; B60R 1/00; H04N 5/272; H04N 7/18; G06T 11/00; H04N 5/247; G06T 7/70; G06K 9/00

(52) U.S. Cl. CPC B62D 15/0275; B60R 1/00; H04N 5/272; H04N 7/18; G06T 11/00; H04N 5/247; B60K 31/00; G06K 9/00791; B60R 2300/304; B60R 2300/806; B60R 2300/607; B60R 2300/105; G06T 7/70

(57) ABSTRACT

A method for providing assistance in a parking maneuver of a vehicle combination of towing vehicle and trailer. The method includes: detecting a stationary object with the aid of a backup camera of the towing vehicle; ascertaining that the object is concealed for the backup camera by the trailer; and superimposing an image element representing the concealed object onto an image of the trailer in an image ascertained by the backup camera.

### FIELD

The present invention relates to a method for providing assistance in a parking maneuver of a vehicle combination of towing vehicle and trailer, system and vehicle combination.

### BACKGROUND INFORMATION

Surround view systems for a parking maneuver assistance, which are typically equipped with three to six cameras, offer a sufficient panoramic view and facilitate in particular the alignment of the vehicle with parking lines. More cost-effective backup camera-based parking maneuver assistance systems offer merely the view behind the vehicle and not the possibility of orienting oneself with respect to static structures in the image. In particular, in this case parallel parking lines of a parking space are no longer visible at the end of a parking maneuver.

U.S. Patent Application No. US 2016/207459 A1 and PCT Application No. WO 2016/082961 A1 respectively describe a method in which previously recorded images of the backup camera are projected into an image area outside of the currently graphically represented view area of the backup camera.

European Patent Application No. EP 2 921 350 A2 describes a video-based (partially) autonomous hitching and unhitching of a trailer.

German Patent Application No. DE 10 2009 012 253 A1 describes a method for performing a parking maneuver of a vehicle combination having a backup camera on the trailer.

### SUMMARY

According to a first aspect, the present invention relates to a method for providing assistance in a parking maneuver of a vehicle combination of towing vehicle and trailer. A “towing vehicle” for this purpose is, in particular, any vehicle capable of pulling a trailer and that is in particular freely maneuverable and drivable and steerable using a motorized drive system such as, e.g., a passenger car and/or a truck and/or a tractor. A “trailer” is in particular any vehicle that is maneuverable in combination with a towing vehicle. This includes in particular a camper trailer and/or a horse trailer and/or other trailers. Accordingly, a vehicle combination is a combination of trailer and towing vehicle. The term “parking maneuver” designates in particular specific driving movements, in particular at speeds below 6 km/h, by vehicle combinations, e.g., steering a truck trailer at loading and unloading locations and/or parking a passenger car by repeated attempts in tight parking spaces. In a first step of the method according to an example embodiment of the present invention, a stationary object, e.g., a ground marking, in particular a parking line, is detected by a backup camera of the towing vehicle. Additionally, the object or a surroundings may also be detected by a front camera of the towing vehicle. In a next step, it is ascertained that the trailer conceals the object for the backup camera. This may be accomplished in particular with the aid of an evaluation unit, e.g., a CPU and/or a microcontroller and/or an electronic control unit, e.g., a head unit, of the means of transport. The concealment may be ascertained on the basis of an analysis of images that are generated from a video input signal of the backup camera. The analysis is in particular an image feature analysis and/or a brightness distribution analysis and/or a color analysis of the image generated from the video signal of the backup camera. A concealment may comprise a spatial obstruction of the field of view of the backup camera on the object by the trailer and/or a shadow cast by the trailer onto the object. In a further step, an image element representing the concealed object, for example a representation of a parking line, is superimposed onto an image of the trailer in an image ascertained by the backup camera. In other words, for providing assistance in the parking maneuver, the object that is no longer visible for the backup camera is projected as a graphic representation onto an image of the trailer so that the object continues to be visible for a user. The graphic representation of the image that is ascertained by the backup camera may occur, e.g., on an instrument cluster display and/or a central information display and/or a head-up display. The method according to the present invention thus makes possible a cost-effective one-camera system for maneuvering assistance in terms of positioning a vehicle combination with respect to stationary surrounding structures in a parking maneuver. This eliminates the need for an additional camera on the trailer.

Preferred developments of the present invention are described herein.

In one preferred development, the method of the present invention comprises the step of generating a bird's eye view image, the bird's eye view image being generated from recordings of the surroundings, which are recorded by the backup camera prior to and/or during the parking maneuver, and having superimposed on it an image of the field of view of the backup camera that is concealed by the trailer in the image. In this step of the method according to the present invention, in particular recordings of the surroundings, which were recorded by the backup camera for example when approaching and/or passing a parking area, are inserted into a bird's eye view image of the display. In particular, it is thus possible to represent the graphical area, which in the image corresponds to the image of the field of view of the backup camera concealed by the trailer, by previous recordings of the surroundings in a realistic manner. This makes it easier for the user to perform the parking maneuver with the vehicle combination. Additionally or alternatively, it is possible to superimpose images or recordings of the surroundings recorded by the backup camera prior to and/or during the parking maneuver, in particular in motion-compensated fashion, over the visualization of the non-visible area of the image. The recordings of the surroundings may be recorded in particular during a forward approach to the parking maneuver area.

In a further advantageous development of the method of the present invention, the image element additionally represents a graphical representation of a trajectory of the trailer. This may be implemented in particular odometrically by ascertaining a steering angle of the towing vehicle. The graphical representation may comprise for example a line and/or a curve.

In another advantageous development, the method of the present invention further comprises the steps of recording the trailer using the alternate rear view mirror camera and ascertaining a position of the image of the trailer in the image ascertained by the backup camera. In other words, it is possible to take into account in particular a movement of the trailer during the parking maneuver. For example, it is possible in response to it to update a position of the trailer in the image ascertained by the backup camera during a parking maneuver. In particular, if the trailer no longer conceals the object, it is possible to remove the image element. This results in a reduction of the degree of distraction on the part of the user and in savings in terms of computing capacity.

In a further advantageous development of the method of the present invention, the object comprises another vehicle that is parked and/or a ground marker, in particular a parking line and/or a lane marker, and/or a plant and/or a building and/or a traffic sign and/or an installation, for example a fire hydrant and/or a traffic sign, and/or a road structure, for example a curbstone, and/or a manhole cover. A specification regarding the type of object to be detected may already be predefined at the factory or may be set by the user. It is also possible for the backup camera to detect several objects and to superimpose these as image element over the image of the trailer in the event that the trailer conceals them in the image presented by the backup camera. Furthermore, it is possible to extrapolate objects, such as lane markers for example, in the image, in particular in linear fashion. In particular, in the event that the object itself is moving, e.g., if a parked vehicle begins to drive, it is possible to classify the latter, in the event of a concealment, as “not certain” or “not stationary”, whereupon a warning, e.g., visually and/or acoustically and/or haptically, may be output to the user. Thus it is possible to increase safety during the parking maneuver.

Furthermore advantageously, it is possible to represent the image element as a function of a steering angle and/or a vehicle speed and/or an acceleration. In particular, conventional odometric methods are possible for this purpose.

In another advantageous development of the first aspect of the present invention, the method of the present invention for providing assistance may be triggered when the vehicle slows below a predefined speed, for example 6 km/h, and/or by an input of the user. In the event of a particularly problematic parking maneuver, the user is thus able to trigger a recording of the surroundings by the backup camera early so that for the purpose of providing assistance during the parking maneuver sufficient image data are available for the user.

In another advantageous development, the method of the present invention comprises the step of ascertaining that the trailer was hitched. This may be achieved by all surroundings sensors available to the towing vehicle, in particular via a trailer hitch sensor and/or an ultrasonic sensor and/or the backup camera. This again makes it possible to save computing capacity since the method of the present invention is not to be performed in a parking maneuver without trailer. Furthermore, it is also possible to decide, e.g., using an electronics system of the towing vehicle, to deactivate an ultrasonic sensor, which detects the trailer permanently in the event that one is hitched.

In one advantageous development, the method according to the present invention comprises the step of filtering the object with regard to whether it has a collision relevance. For example, different collision relevancies for different objects may be assigned to a predefined reference in a memory of the electronics system of the towing vehicle. If for example a hydrant is ascertained by the backup camera, a high collision relevance may be assigned to this hydrant. In the case of a ground marker, an attribute “no collision relevance” may be assigned to it, for example. The position of the hydrant may be ascertained for example by the backup camera. In the case of a concealment by the trailer, it is possible to ascertain an approach to the hydrant odometrically. For example, the object, that is, e.g., the hydrant, may then be color coded (green to red) by the superimposed image element depending on the “collision risk”. Furthermore or alternatively, it is also possible for an acoustic warning to be output, in particular a trill and/or a honk and/or a beep, and/or a haptic feedback such as, e.g., a vibration of the steering wheel. Additionally or alternatively, an object may also be filtered according to a towing vehicle guidance relevance. For this purpose, objects may also be classified on the basis of a predefined reference. In this case, the classification may be in particular hierarchical. For example, a parking line may be assigned a higher rank than a manhole cover. In particular, objects of a low rank may be filtered out. Thus it is possible to design the superimposition of the image of the trailer in a manner that is clearer for the driver.

The following aspects of the present invention comprise advantageous developments and refinements having the aforementioned technical features as well as the general advantages of the method of the present invention and the respectively associated technical effects. To avoid repetitions, a new enumeration is omitted below for this reason.

According to a second aspect, the present invention relates to a system that is designed to implement the method according to the first aspect of the present invention. In accordance with an example embodiment of the present invention, the system may be comprised in particular by a vehicle combination (of towing vehicle and trailer). The towing vehicle comprises in particular a backup camera that is designed to detect a stationary object and an evaluation unit designed to ascertain a concealment of the stationary object by a trailer, and which is further designed to superimpose an image element representing the concealed object onto an image of the trailer in an image ascertained by the backup camera, and a display designed to display the image.

According to a third aspect, the present invention relates to a vehicle combination, which comprises a system in accordance with the second aspect of the present invention.

### BRIEF DESCRIPTION OF THE DRAWINGS

Exemplary embodiments of the present invention are described in detail below with reference to the figures.

FIG. 1 shows a specific embodiment of the vehicle combination according to the present invention.

FIG. 2 shows a bird's-eye view of a specific embodiment of the vehicle combination according to the present invention.

FIG. 3 shows an illustration of method steps according to a specific embodiment of the method according to the present invention.

FIG. 4 shows an illustration of method steps according to another specific embodiment of the method according to the present invention.

FIG. 5 shows a flow chart of one specific embodiment of the method according to the present invention.

### DETAILED DESCRIPTION OF EXAMPLE EMBODIMENTS

FIG. 1 shows a specific embodiment of the vehicle combination 10 according to the present invention comprising a towing vehicle 5, here in the form of a passenger car, and a trailer 6. Vehicle combination 10 further comprises a system 1 according to the present invention, which comprises a display 4, an evaluation unit 2 and a backup camera 3. With the aid of evaluation unit 2, backup camera 3 is designed to ascertain whether an object 11, here in the form of a sign, which was previously detected by the field of view 7 of backup camera 3, is concealed by trailer 6. Display 4, which is connected to evaluation unit 2, displays a corresponding image, which includes an image of trailer 6 and an image element 13 representing object 11 superimposed on this image if trailer 6 conceals field of view 7 onto object 11.

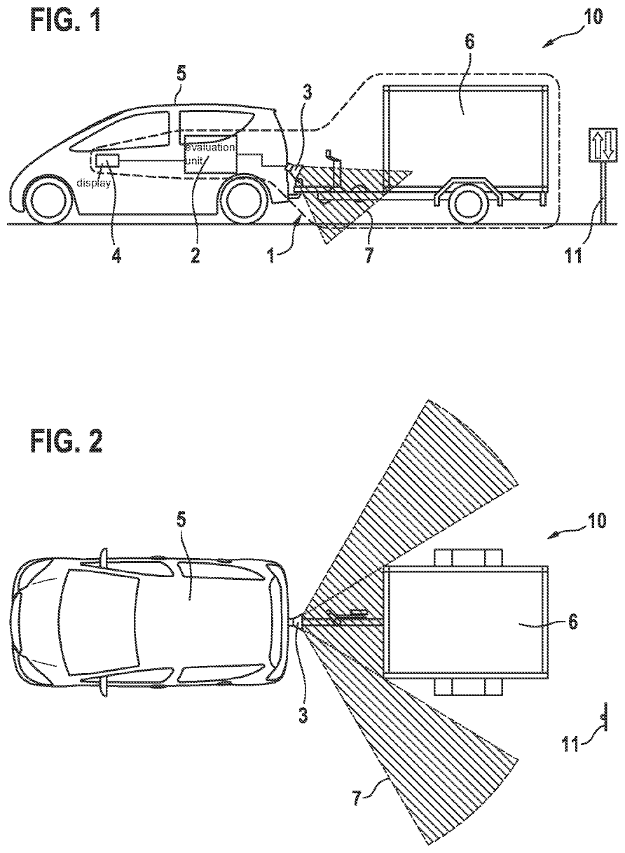

FIG. 2 shows a specific embodiment of the vehicle combination 10 of the present invention from a bird's-eye perspective.

FIG. 3 shows an illustration of method steps of a specific embodiment of the method according to the present invention via corresponding bird's-eye view images, which respectively show an image of towing vehicle 5, an image of trailer 6, and an image of field of view 7 of backup camera 3. The tiles in FIG. 3 illustrate the steps S1 through S6. For step S1, a bird's-eye view image of vehicle combination 10 driving forward is shown, which is indicated by forward arrow 8. In the process, backup camera 3 detects an object 11 (in the present case parking lines 9 on the roadway). For step S2, the start of the parking maneuver is shown. In this instance, parking lines 9 are not shown due to the concealed field of view 12. Upon triggering of the method of the present invention for providing assistance in a parking maneuver in step S3, image elements 13 representing the object are projected into the concealed area. In the illustrations of steps S4 through S6, trailer 6 is at the same time recorded by backup camera 3 and its position is continuously ascertained in order to allow for an orientation along parking lines 9. Image elements 13 are then superimposed onto the image of the concealed field of view 12 and the image of trailer 6 if the real parking lines 9 are not detectable for backup camera 3 due to a concealment.

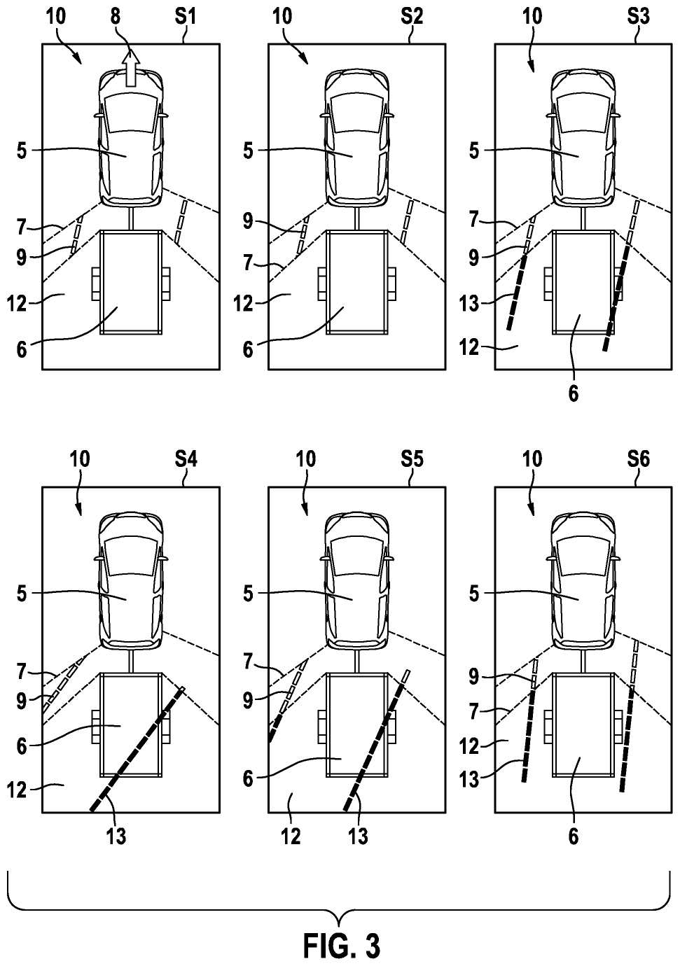

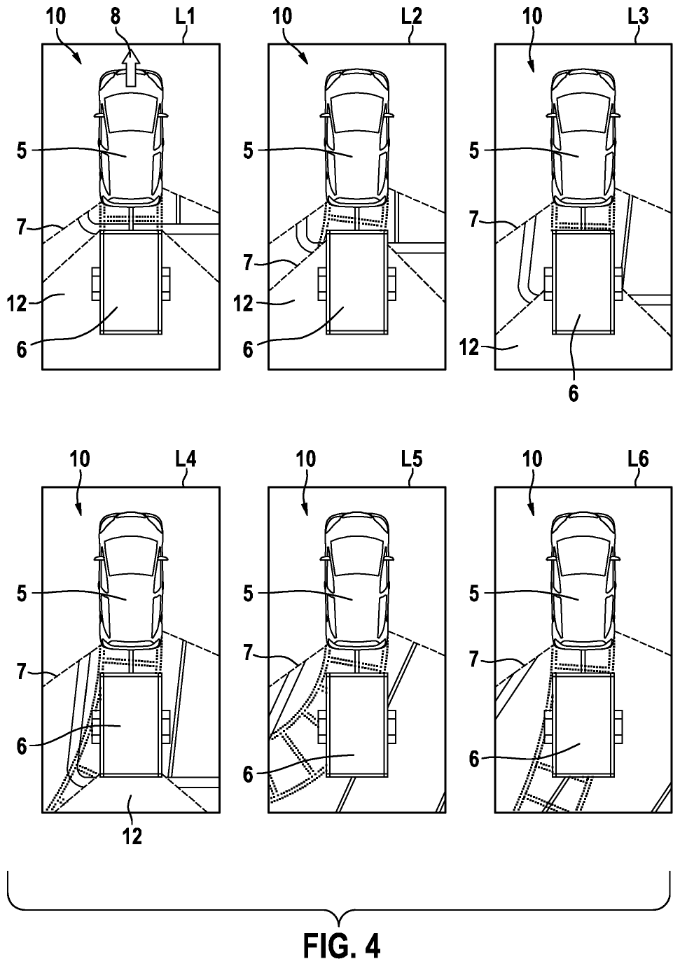

FIG. 4 shows an illustration of method steps according to the present invention, in which recordings of the surroundings made prior to the start and during the parking maneuver, which are recorded by backup camera 3, are inserted into the bird's-eye view image. The tiles within FIG. 4 illustrate method steps L1 through L6. In step L1, during the forward drive (prior to the start of the parking maneuver), and in step L2 during the start of the parking maneuver, images of the surroundings recorded by backup camera 3 are stored. In step L3, previously recorded images are superimposed onto the image of the concealed field of view 12, as a result of which the image of concealed field of view 12 is depicted as reduced in area compared to the real concealed field of view 12. In steps L4 through L6, the previously recorded backup camera images are superimposed onto the image of concealed field of view 12 in a manner that compensates for motion. Such images, which are produced in a motion-compensated manner, may be displayed, e.g., in comic strip-like fashion in the form of a “3D art map” and/or as a dashed drawing and/or as a ghost image and/or as a gradient image. This may be accomplished, e.g., on a 3D graphics processor of evaluation unit 2, in particular of a head unit.

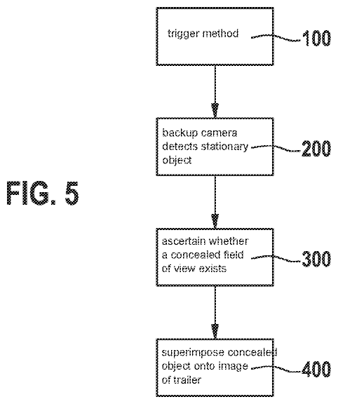

FIG. 5 shows a flow chart of a specific embodiment of the method according to the present invention. In a first step 100, the method of the invention for providing support in a parking maneuver is triggered by towing vehicle 5 driving slowly, for example at a speed of <6 km/h. In response, backup camera 3 of towing vehicle 5 detects a stationary object 11, for example a parking line 9, in second step 200. In third step 300, an ascertainment is made, for example by an evaluation unit 2, whether a concealed field of view 12 exists, which may be caused by trailer 6 concealing object 11. If such a concealment exists, then, in a fourth step 400, an image element 13 representing concealed object 11 is superimposed onto an image of trailer 6 in an image ascertained by backup camera 3, which is displayed, e.g., on a display 4.

1-11. (canceled).

12. A method for providing assistance in a parking maneuver of a vehicle combination of towing vehicle and trailer, the method comprising the following steps:
detecting a stationary object using using a backup camera of the towing vehicle;
ascertaining that the object is concealed for the backup camera by the trailer; and
superimposing an image element representing the concealed object onto an image of the trailer in an image ascertained by the backup camera.

13. The method as recited in claim 12, further comprising:
generating a bird's-eye view image from recordings of surroundings, which were recorded by the backup camera prior to and/or during the parking maneuver, and of superimposing the bird's-eye view onto an image of a field of view concealed in the image by the trailer; and/or
superimposing recordings of the surroundings, which are recorded by the backup camera prior to and/or during the parking maneuver, over the image of the field of view concealed by the trailer.

14. The method as recited in claim 12, wherein the image element additionally represents a graphical representation of a trajectory of the trailer.

15. The method as recited in claim 12, further comprising the following steps:
detecting the trailer using the alternate rear view mirror camera; and
ascertaining a position of the image of the trailer (6) in the image ascertained by the backup camera.

16. The method as recited in claim 12, wherein the object is a parked second vehicle and/or a ground marking and/or a plant and/or a building and/or a road structure and/or an installation and/or a manhole cover.

17. The method as recited in claim 12, wherein the image element is represented as a function of a steering angle and/or a vehicle speed and/or an acceleration.

18. The method as recited in claim 12, further comprising:
triggering the method for providing assistance by slowing below a predefined speed and/or by a user input.

19. The method as recited in claim 12, further comprising:
ascertaining that the trailer is hitched.

20. The method as recited in claim 12, further comprising:
filtering the object as to whether it has a collision relevance and/or a towing vehicle guidance relevance.

21. A system for providing assistance in a parking maneuver of a vehicle combination of towing vehicle and trailer, the system configured to:
detect a stationary object using using a backup camera of the towing vehicle;
ascertain that the object is concealed for the backup camera by the trailer; and
superimpose an image element representing the concealed object onto an image of the trailer in an image ascertained by the backup camera.

22. A vehicle combination, comprising:
a towing vehicle and a trailer; and
a system for providing assistance in a parking maneuver of the towing vehicle and the trailer, the system configured to:
detect a stationary object using using a backup camera of the towing vehicle;
ascertain that the object is concealed for the backup camera by the trailer; and
superimpose an image element representing the concealed object onto an image of the trailer in an image ascertained by the backup camera.
